(19) United States
(12) Patent Application Publication
(10) Pub. No.: US 2023/0153626 A1
(43) Pub. Date: May 18, 2023

(54) METHOD AND APPARATUS FOR SUPPORTING AUTOMATED RE-LEARNING IN MACHINE TO MACHINE SYSTEM

(71) Applicants: Hyundai Motor Company, Seoul (KR); Kia Corporation, Seoul (KR); Industry Academy Cooperation Foundation of Sejong University, Seoul (KR)

(72) Inventor: Jae Seung Song, Seoul (KR)

(21) Appl. No.: 17/988,601

(22) Filed: Nov. 16, 2022

Related U.S. Application Data
(60) Provisional application No. 63/280,319, filed on Nov. 17, 2021.

(51) Int. Cl. G06N 3/084; G06N 3/088

(52) U.S. Cl. CPC G06N 3/084; G06N 3/088

(57) ABSTRACT

The present disclosure may support automated re-learning in a machine-to-machine (M2M) system. A method for operating a device may include: generating a resource for training an artificial intelligence (AI) model; controlling to perform initial learning of the AI model; collecting learning data for re-learning for the AI model; and controlling to perform re-learning of the AI model by using the learning data.

### CROSS REFERENCE TO RELATED APPLICATION

The present application claims priority to a U.S. provisional application 63/280,319, filed Nov. 17, 2021, the entire contents of which is incorporated herein for all purposes by this reference.

### BACKGROUND OF THE DISCLOSURE

### Field of the Disclosure

The present disclosure relates to a machine-to-machine (M2M) system and, more particularly, to a method and apparatus for supporting automated re-learning in the M2M system.

### Description of the Related Art

Recently, introduction of Machine-to-Machine (M2M) system has become active. An M2M communication may refer to a communication performed between machines without human intervention. M2M may refer to Machine Type Communication (MTC), Internet of Things (IoT) or Device-to-Device (D2D). In the following description, the term “M2M” may be uniformly used for convenience of explanation, but the present disclosure may not be limited thereto. A terminal used for M2M communication may be an M2M terminal or an M2M device. An M2M terminal may generally be a device having low mobility while transmitting a small amount of data. Herein, the M2M terminal may be used in connection with an M2M server that centrally stores and manages inter-machine communication information. In addition, an M2M terminal may be applied to various systems such as object tracking, automobile linkage, and power metering.

Meanwhile, with respect to an M2M terminal, the oneM2M standardization organization provides requirements for M2M communication, things to things communication and IoT technology, and technologies for architecture, Application Program Interface (API) specifications, security solutions and interoperability. The specifications of the oneM2M standardization organization provide a framework to support a variety of applications and services such as smart cities, smart grids, connected cars, home automation, security and health.

### SUMMARY

The present disclosure provides a method and apparatus for effectively performing learning for an artificial intelligence (AI) model in a machine-to-machine (M2M) system.

The present disclosure provides a method and apparatus for supporting automated re-learning in an M2M system.

The present disclosure provides a method and apparatus for properly triggering re-learning for an AI model in an M2M system.

According to an embodiment of the present disclosure, a method for operating a device in an M2M system may include: generating a resource for training an artificial intelligence (AI) model; controlling to perform initial learning of the AI model; collecting learning data for re-learning of the AI model; and controlling to perform re-learning of the AI model by using the learning data.

According to an embodiment of the present disclosure, a transceiver and a processor coupled with the transceiver may be included. The processor may be configured to generate a resource for training an artificial intelligence (AI) model, to perform initial learning of the AI model, to collect learning data for re-learning the AI model, and to perform re-learning of the AI model by using the learning data.

According to the present disclosure, learning for an artificial intelligence (AI) model may be effectively performed in a machine-to-machine (M2M) system.

Effects obtained in the present disclosure are not limited to the above-mentioned effects, and other effects not mentioned above may be clearly understood by those skilled in the art from the following description.

### BRIEF DESCRIPTION OF THE DRAWINGS

The above and other objects, features and advantages of the present disclosure will be more clearly understood from the following detailed description taken in conjunction with the accompanying drawings.

FIG. 1 illustrates a layered structure of a machine-to-machine (M2M) system according to the present disclosure.

FIG. 2 illustrates a reference point in an M2M system according to the present disclosure.

FIG. 3 illustrates each node in an M2M system according to the present disclosure.

FIG. 4 illustrates a common service function in an M2M system according to the present disclosure.

FIG. 5 illustrates a method in which an originator and a receiver exchange a message in an M2M system according to the present disclosure.

FIG. 6 illustrates a concept of re-learning supported in an M2M system according to the present disclosure.

FIG. 7 illustrates an example of a resource including information on re-learning in an M2M system according to the present disclosure.

FIG. 8 illustrates an example of a procedure of controlling learning for an AI model in an M2M system according to the present disclosure.

FIG. 9 illustrates an example of a procedure of performing re-learning in an M2M system according to the present disclosure.

FIG. 10 illustrates a configuration of an M2M device in an M2M system according to the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In the present disclosure, the terms first, second, etc. may be used only for the purpose of distinguishing one component from another, and do not limit the order or importance of components, etc. unless specifically stated otherwise. Thus, within the scope of this disclosure, a first component in one embodiment may be referred to as a second component in another embodiment, and similarly a second component in one embodiment may be referred to as a first component. In addition, as understood by a person of skill in the art reading the present disclosure, the components may not be separated, but merely indicate different functions for a single component structure. For example, a first memory for storing data A and a second memory for storing data B may include either separate memory for storing the separate data or could, in fact, be implemented in a single memory unit that stores both data A and data B.

In the present disclosure, when a component may be referred to as being “linked”, “coupled”, or “connected” to another component, it may be understood that not only a direct connection relationship but also an indirect connection relationship through an intermediate component may also be included. Also, when a component may be referred to as “comprising” or “having” another component, it may mean further inclusion of another component not the exclusion thereof, unless explicitly described to the contrary.

In the present disclosure, components that may be distinguished from each other may be intended to clearly illustrate each feature. However, it does not necessarily mean that the components may be separate. In other words, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment may be also included within the scope of the present disclosure. Also, exemplary embodiments that include other components in addition to the components described in the various exemplary embodiments may also be included in the scope of the present disclosure.

In the following description of the embodiments of the present disclosure, a detailed description of known functions and configurations incorporated herein will be omitted when it may make the subject matter of the present disclosure rather unclear. Parts not related to the description of the present disclosure in the drawings may be omitted, and like parts may be denoted by similar reference numerals.

Although an exemplary embodiment may be described as using a plurality of units to perform the exemplary process, it may be understood that the exemplary processes may also be performed by one or plurality of modules. Additionally, it may be understood that the term controller/control unit refers to a hardware device that includes a memory and a processor and may be specifically programmed to execute the processes described herein. The memory may be configured to store the modules and the processor may be specifically configured to execute said modules to perform one or more processes which may be described further below.

In addition, the present specification describes a network based on Machine-to-Machine (M2M) communication, and a work in M2M communication network may be performed in a process of network control and data transmission in a system managing the communication network. In the present specification, an M2M terminal may be a terminal performing M2M communication. However, in consideration of backward compatibility, it may be a terminal operating in a wireless communication system. In other words, an M2M terminal may refer to a terminal operating based on M2M communication network but may not be limited thereto. An M2M terminal may operate based on another wireless communication network and may not be limited to the exemplary embodiment described above.

In addition, an M2M terminal may be fixed or have mobility. An M2M server refers to a server for M2M communication and may be a fixed station or a mobile station. In the present specification, an entity may refer to hardware like M2M device, M2M gateway and M2M server. In addition, for example, an entity may be used to refer to software configuration in a layered structure of M2M system and may not be limited to the embodiment described above.

In addition, for example, the present disclosure mainly describes an M2M system but may not be solely applied thereto. In addition, an M2M server may be a server that performs communication with an M2M terminal or another M2M server. In addition, an M2M gateway may be a connection point between an M2M terminal and an M2M server. For example, when an M2M terminal and an M2M server have different networks, the M2M terminal and the M2M server may be connected to each other through an M2M gateway. Herein, for example, both an M2M gateway and an M2M server may be M2M terminals and may not be limited to the embodiment described above.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The present disclosure relates to a method and device for performing learning for an artificial intelligence (AI) model in a machine-to-machine (M2M) system. More particularly, the present disclosure describes a technology of supporting re-learning after initial learning for an AI model in an M2M system.

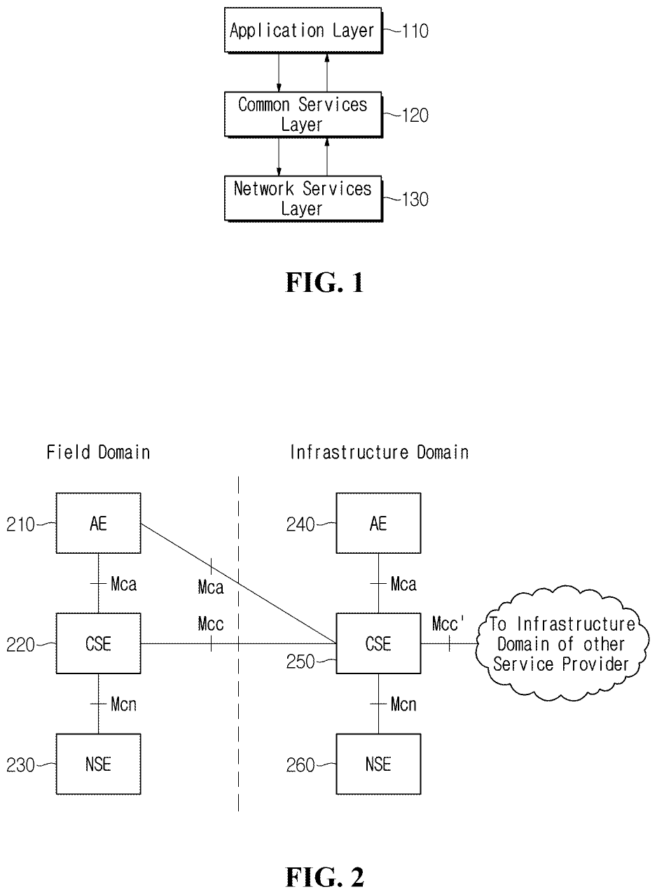

oneM2M may be a de facto standards organization that was founded to develop a communal IoT service platform sharing and integrating application service infrastructure (platform) environments beyond fragmented service platform development structures limited to separate industries like energy, transportation, national defense and public service. oneM2M aims to render requirements for things to things communication and IoT technology, architectures, Application Program Interface (API) specifications, security solutions and interoperability. For example, the specifications of oneM2M provide a framework to support a variety of applications and services such as smart cities, smart grids, connected cars, home automation, security and health. In this regard, oneM2M has developed a set of standards defining a single horizontal platform for data exchange and sharing among all the applications. Applications across different industrial sections may also be considered by oneM2M. Like an operating system, oneM2M provides a framework connecting different technologies, thereby creating distributed software layers facilitating unification. Distributed software layers may be implemented in a common services layer between M2M applications and communication Hardware/Software (HW/SW) rendering data transmission. For example, a common services layer may be a part of a layered structure illustrated in FIG. 1. The oneM2M standards are referred to herein and incorporated in their entirety into this application. Specifically, the technical specification of the oneM2M Functional Architecture is referred to herein and incorporated herein in its entirety. See Document No. TS-0001-V4.8.0, Functional Architecture and Document No. TS-0001-V3.15.1, Functional Architecture.

FIG. 1 illustrates a layered structure of an Machine-to-Machine (M2M) system according to the present disclosure. Referring to FIG. 1, a layered structure of an M2M system may include an application layer 110, a common services layer 120 and a network services layer 130. Herein, the application layer 110 may be configured as a layer operating based on a specific application. For example, an application may be a fleet tracking application, a remote blood sugar monitoring application, a power metering application or a controlling application. In other words, an application layer may be a layer for a specific application. Herein, an entity operating based on an application layer may be an application entity (AE).

The common services layer 120 may be configured as a layer for a common service function (CSF). For example, the common services layer 120 may be a layer for providing common services like data management, device management, M2M service subscription management and location service. For example, an entity operating based on the common services layer 120 may be a common service entity (CSE).

The common services layer 120 may be configured to provide a set of services that may be grouped into CSFs according to functions. A multiplicity of instantiated CSFs constitutes CSEs. CSEs may interface with applications (for example, application entities or AEs in the terminology of oneM2M), other CSEs and base networks (for example, network service entities or NSEs in the terminology of oneM2M). The network services layer 130 may be configured to provide the common services layer 120 with services such as device management, location service and device triggering. Herein, an entity operating based on the network layer 120 may be a network service entity (NSE).

FIG. 2 illustrates reference points in an M2M system according to the present disclosure. Referring to FIG. 2, an M2M system structure may be distinguished into a field domain and an infrastructure domain. Herein, in each domain, each of the entities may perform communication through a reference point (for example, Mca or Mcc). For example, a reference point may indicate a communication flow between each entity. In particular, referring to FIG. 2, the reference point Mca between AE 210 or 240 and CSE 220 or 250, the reference point Mcc between different CSEs and Mcn reference point between CSE 220 or 250 and NSE 230 or 260 may be set.

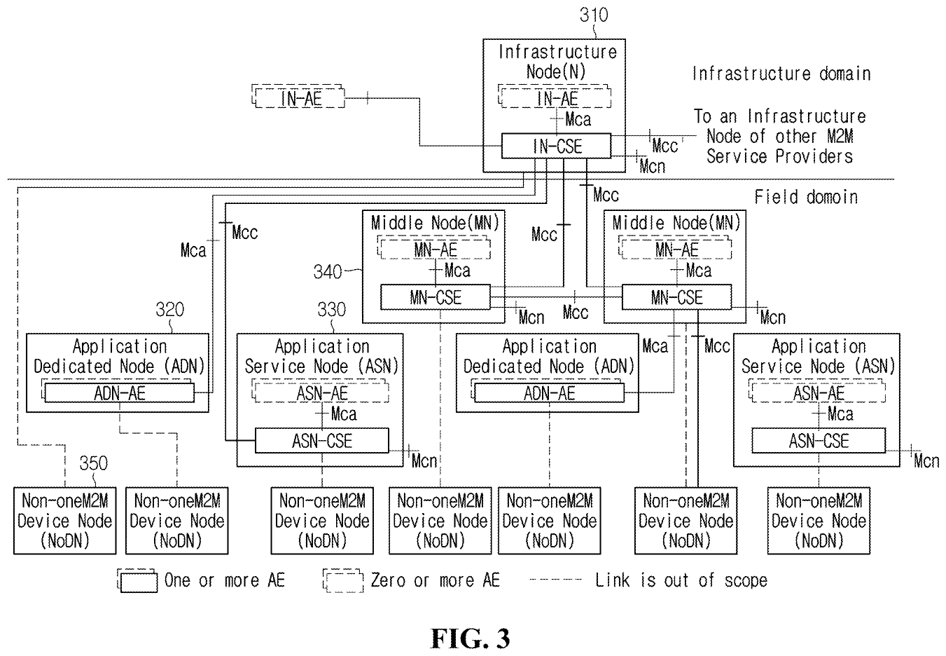

FIG. 3 illustrates each node in an M2M system according to the present disclosure. Referring to FIG. 3, an infrastructure domain of a specific M2M service provider may be configured to provide a specific infrastructure node (IN) 310. Herein, the CSE of the IN may be configured to perform communication based on the AE and the reference point Mca of another infrastructure node. In particular, one IN may be set for each M2M service provider. In other words, the IN may be a node that performs communication with the M2M terminal of another infrastructure based on an infrastructure structure. In addition, for example, conceptually, a node may be configured as a logical entity or a software configuration.

Next, an application dedicated node (ADN) 320 may be a node including at least one AE but not CSE. In particular, an ADN may be set in the field domain. In other words, an ADN may be a dedicated node for AE. For example, an ADN may be a node that may be set in an M2M terminal in hardware. In addition, the application service node (ASN) 330 may be a node including one CSE and at least one AE. ASN may be set in the field domain. In other words, it may be a node including AE and CSE. In particular, an ASN may be a node connected to an IN. For example, an ASN may be a node that may be set in an M2M terminal in hardware.

In addition, a middle node (MN) 340 may be a node including a CSE and including zero or more AEs. In particular, the MN may be set in the field domain. An MN may be connected to another MN or IN based on a reference point. In addition, for example, an MN may be set in an M2M gateway in hardware. As an example, a non-M2M terminal node 350 (Non-M2M device node, NoDN) may be a node that does not include M2M entities. It may be a node that performs management or collaboration together with an M2M system.

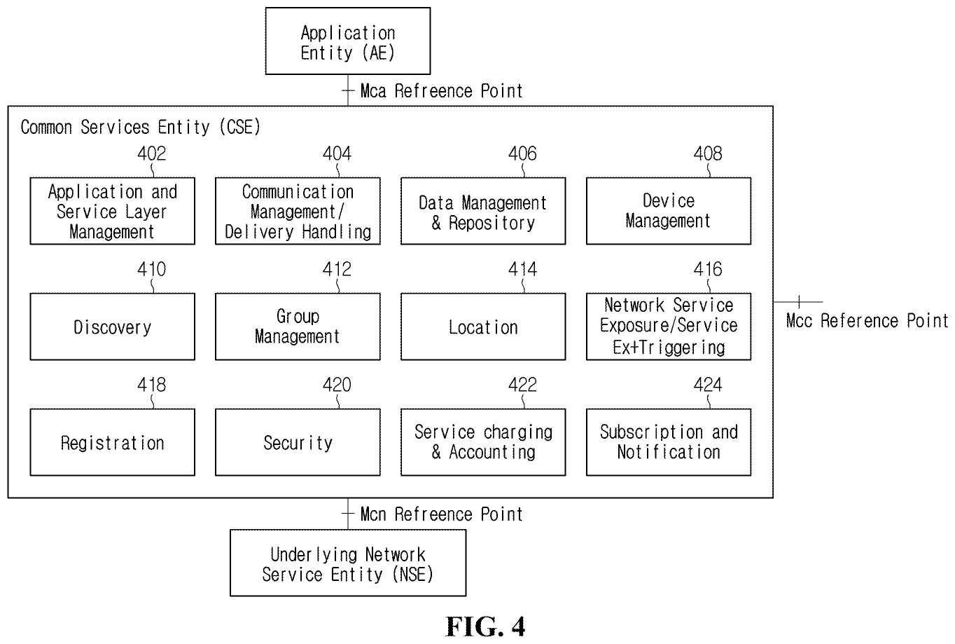

FIG. 4 illustrates a common service function in an M2M system according to the present disclosure. Referring to FIG. 4, common service functions may be provided. For example, a common service entity may be configured to provide at least one or more CSFs among application and service layer management 402, communication management and delivery handling 404, data management and repository 406, device management 408, discovery 410, group management 412, location 414, network service exposure/service execution and triggering 416, registration 418, security 420, service charging and accounting 422, service session management and subscription/notification 424. At this time, M2M terminals may operate based on a common service function. In addition, a common service function may be possible in other embodiments and may not be limited to the above-described exemplary embodiment.

The application and service layer management 402 CSF may be configured to provide management of AEs and CSEs. The application and service layer management 402 CSF may be configured to include not only the configuring, problem solving and upgrading of CSE functions but also the capability of upgrading AEs. The communication management and delivery handling 404 CSF may be configured to provide communications with other CSEs, AEs and NSEs. The communication management and delivery handling 404 CSF may be configured to determine at what time and through what connection communications may be delivered, and also determine to buffer communication requests to deliver the communications later, if necessary and permitted.

The data management and repository 406 CSF may be configured to provide data storage and transmission functions (for example, data collection for aggregation, data reformatting, and data storage for analysis and sematic processing). The device management 408 CSF may be configured to provide the management of device capabilities in M2M gateways and M2M devices.

The discovery 410 CSF may be configured to provide an information retrieval function for applications and services based on filter criteria. The group management 412 CSF may be configured to provide processing of group-related requests. The group management 412 CSF may be configured to enable an M2M system to support bulk operations for many devices and applications. The location 414 CSF may be configured to enable AEs to obtain geographical location information.

The network service exposure/service execution and triggering 416 CSF may be configured to manage communications with base networks for access to network service functions. The registration 418 CSF may be configured to provide AEs (or other remote CSEs) to a CSE. The registration 418 CSF may be configured to allow AEs (or remote CSE) to use services of CSE. The security 420 CSF may be configured to provide a service layer with security functions like access control including identification, authentication and permission. The service charging and accounting 422 CSF may be configured to provide charging functions for a service layer. The subscription/notification 424 CSF may be configured to allow subscription to an event and notifying the occurrence of the event.

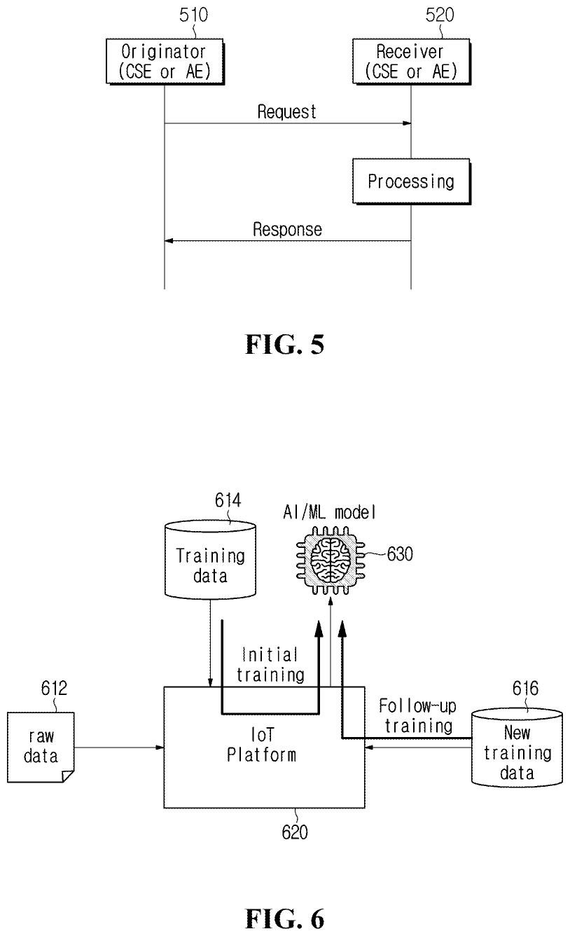

FIG. 5 illustrates an exchange of a message between an originator and a receiver in an M2M system according to the present disclosure. Referring to FIG. 5, the originator 501 may be configured to transmit a request message to the receiver 520. In particular, the originator 510 and the receiver 520 may be the above-described M2M terminals. However, the originator 510 and the receiver 520 may not be limited to M2M terminals but may be other terminals. They may not be limited to the above-described exemplary embodiment. In addition, for example, the originator 510 and the receiver 520 may be nodes, entities, servers or gateways, which may be described above. In other words, the originator 510 and the receiver 520 may be hardware or software configurations and may not be limited to the above-described embodiment.

Herein, for example, a request message transmitted by the originator 510 may include at least one parameter. Additionally, a parameter may be a mandatory parameter or an optional parameter. For example, a parameter related to a transmission terminal, a parameter related to a receiving terminal, an identification parameter and an operation parameter may be mandatory parameters. In addition, optional parameters may be related to other types of information. In particular, a transmission terminal-related parameter may be a parameter for the originator 510. In addition, a receiving terminal-related parameter may be a parameter for the receiver 520. An identification parameter may be a parameter required for identification of each other.

Further, an operation parameter may be a parameter for distinguishing operations. For example, an operation parameter may be set to any one among Create, Retrieve, Update, Delete or Notify. In other words, the parameter may aim to distinguish operations. In response to receiving a request message from the originator 510, the receiver 520 may be configured to process the message. For example, the receiver 520 may be configured to perform an operation included in a request message. For the operation, the receiver 520 may be configured to determine whether a parameter may be valid and authorized. In particular, in response to determining that a parameter may be valid and authorized, the receiver 520 may be configured to check whether there may be a requested resource and perform processing accordingly.

For example, in case an event occurs, the originator 510 may be configured to transmit a request message including a parameter for notification to the receiver 520. The receiver 520 may be configured to check a parameter for a notification included in a request message and may perform an operation accordingly. The receiver 520 may be configured to transmit a response message to the originator 510.

A message exchange process using a request message and a response message, as illustrated in FIG. 5, may be performed between AE and CSE based on the reference point Mca or between CSEs based on the reference point Mcc. In other words, the originator 510 may be AE or CSE, and the receiver 520 may be AE or CSE. According to an operation in a request message, such a message exchange process as illustrated in FIG. 5 may be initiated by either AE or CSE.

A request from a requestor to a receiver through the reference points Mca and Mcc may include at least one mandatory parameter and at least one optional parameter. In other words, each defined parameter may be either mandatory or optional according to a requested operation. For example, a response message may include at least one parameter among those listed in Table 1 below.

TABLE 1
Response message parameter/success or not

Response Status Code - successful, unsuccessful, ack
Request Identifier - uniquely identifies a Request message
Content - to be transferred
To - the identifier of the Originator or the Transit CSE
that sent the corresponding non-blocking request
From - the identifier of the Receiver
Originating Timestamp - when the message was built
Result Expiration Timestamp - when the message expires
Event Category - what event category shall be used for
the response message
Content Status
Content Offset
Token Request Information
Assigned Token Identifiers
Authorization Signature Request Information
Release Version Indicator - the oneM2M release version that this
response message conforms to

A filter criteria condition, which may be used in a request message or a response message, may be defined as in Table 2 and Table 3 below.

TABLE 2

| | | |
|---|---|---|
| Condition tag | Multiplicity | Description |

Matching Conditions

| | | |
|---|---|---|
| createdBefore | 0 . . . 1 | The creationTime attribute of the matched resource is |
| | | chronologically before the specified value. |
| createdAfter | 0 . . . 1 | The creationTime attribute of the matched resource is |
| | | chronologically after the specified value. |
| modifiedSince | 0 . . . 1 | The lastModifiedTime attribute of the matched resource is |
| | | chronologically after the specified value. |
| unmodifiedSince | 0 . . . 1 | The lastModifiedTime attribute of the matched resource is |
| | | chronologically before the specified value. |
| stateTagSmaller | 0 . . . 1 | The stateTag attribute of the matched resource is smaller than the |
| | | specified value. |
| stateTagBigger | 0 . . . 1 | The stateTag attribute of the matched resource is bigger than the |
| | | specified value. |
| expireBefore | 0 . . . 1 | The expirationTime attribute of the matched resource is |
| | | chronologically before the specified value. |
| expireAfter | 0 . . . 1 | The expirationTime attribute of the matched resource is |
| | | chronologically after the specified value. |
| labels | 0 . . . 1 | The labels attribute of the matched resource matches the specified |
| | | value. |
| labelsQuery | 0 . . . 1 | The value is an expression for the filtering of labels attribute of |
| | | resource when it is of key-value pair format. The expression is |
| | | about the relationship between label-key and label-value which |
| | | may include equal to or not equal to, within or not within a |
| | | specified set etc. For example, label-key equals to label value, or |
| | | label-key within {label-value1, label-value2}. |
| childLabels | 0 . . . 1 | A child of the matched resource has labels attributes matching the |
| | | specified value. The evaluation is the same as for the labels |
| | | attribute above. |
| parentLabels | 0 . . . 1 | The parent of the matched resource has labels attributes matching |
| | | the specified value. The evaluation is the same as for the labels |
| | | attribute above. |
| resourceType | 0 . . . n | The resourceType attribute of the matched resource is the same as |
| | | the specified value. It also allows differentiating between normal |
| | | and announced resources. |
| childResourceType | 0 . . . n | A child of the matched resource has the resourceType attribute the |
| | | same as the specified value. |
| parentResourceType | 0 . . . 1 | The parent of the matched resource has the resourceType attribute |
| | | the same as the specified value. |
| sizeAbove | 0 . . . 1 | The contentsize attribute of the <contentInstance> matched |
| | | resource is equal to or greater than the specified value. |
| sizeBelow | 0 . . . 1 | The contentsize attribute of the <contentInstance> matched |
| | | resource is smaller than the specified value. |
| contentType | 0 . . . n | The contentinfo attribute of the <contentInstance> matched |
| | | resource matches the specified value. |
| attribute | 0 . . . n | This is an attribute of resource types (clause 9.6). Therefore, a real |
| | | tag name is variable and depends on its usage and the value of the |
| | | attribute can have wild card *. E.g. creator of container resource |
| | | type can be used as a filter criteria tag as “creator = Sam”, |
| | | “creator = Sam*”, “creator = *Sam”. |
| childAttribute | 0 . . . n | A child of the matched resource meets the condition provided. |
| | | The evaluation of this condition is similar to the attribute |
| | | matching condition above. |
| parentAttribute | 0 . . . n | The parent of the matched resource meets the condition provided. |
| | | The evaluation of this condition is similar to the attribute |
| | | matching condition above. |
| semanticsFilter | 0 . . . n | Both semantic resource discovery and semantic query use |
| | | semanticsFilter to specify a query statement that shall be specified |
| | | in the SPARQL query language [5]. When a CSE receives a |
| | | RETRIEVE request including a semanticsFilter, and the Semantic |
| | | Query Indicator parameter is also present in the request, the |
| | | request shall be processed as a semantic query; otherwise, the |
| | | request shall be processed as a semantic resource discovery. |
| | | In the case of semantic resource discovery targeting a specific |
| | | resource, if the semantic description contained in |
| | | the <semanticDescriptor> of a child resource matches the |
| | | semanticFilter, the URI of this child resource will be included in |
| | | the semantic resource discovery result. |
| | | In the case of semantic query, given a received semantic query |
| | | request and its query scope, the SPARQL query statement shall be |
| | | executed over aggregated semantic information collected from the |
| | | semantic resource(s) in the query scope and the produced output |
| | | will be the result of this semantic query. |
| | | Examples for matching semantic filters in SPARQL to semantic |
| | | descriptions can be found in [i.28]. |
| filterOperation | 0 . . . 1 | Indicates the logical operation (AND/OR) to be used for different |
| | | condition tags. The default value is logical AND. |
| contentFilterSyntax | 0 . . . 1 | Indicates the Identifier for syntax to be applied for content-based |
| | | discovery. |
| contentFilterQuery | 0 . . . 1 | The query string shall be specified when contentFilterSyntax |
| | | parameter is present. |

TABLE 3

| | | |
|---|---|---|
| Condition tag | Multiplicity | Description |

Filter Handling Conditions

| | | |
|---|---|---|
| filterUsage | 0 . . . 1 | Indicates how the filter criteria is used. If provided, possible values |
| | | are ‘discovery’ and ‘IPEOnDemandDiscovery’. |
| | | If this parameter is not provided, the Retrieve operation is a |
| | | generic retrieve operation and the content of the child resources |
| | | fitting the filter criteria is returned. |
| | | If filterUsage is ‘discovery’, the Retrieve operation is for resource |
| | | discovery (clause 10.2.6), i.e. only the addresses of the child |
| | | resources are returned. |
| | | If filterUsage is ‘IPEOnDemandDiscovery’, the other filter |
| | | conditions are sent to the IPE as well as the discovery Originator |
| | | ID. When the IPE successfully generates new resources matching |
| | | with the conditions, then the resource address(es) shall be returned. |
| | | This value shall only be valid for the Retrieve request targeting |
| | | an <AE> resource that represents the IPE. |
| limit | 0 . . . 1 | The maximum number of resources to be included in the filtering |
| | | result. This may be modified by the Hosting CSE. When it is |
| | | modified, then the new value shall be smaller than the suggested |
| | | value by the Originator. |
| level | 0 . . . 1 | The maximum level of resource tree that the Hosting CSE shall |
| | | perform the operation starting from the target resource (i.e. To |
| | | parameter). This shall only be applied for Retrieve operation. The |
| | | level of the target resource itself is zero and the level of the direct |
| | | children of the target is one. |
| offset | 0 . . . 1 | The number of direct child and descendant resources that a Hosting |
| | | CSE shall skip over and not include within a Retrieve response |
| | | when processing a Retrieve request to a targeted resource. |
| applyRelativePath | 0 . . . 1 | This attribute contains a resource tree relative path |
| | | (e.g. . . . /tempContainer/LATEST). This condition applies after all |
| | | the matching conditions have been used (i.e. a matching result has |
| | | been obtained). The attribute determines the set of resource(s) in |
| | | the final filtering result. The filtering result is computed by |
| | | appending the relative path to the path(s) in the matching result. |
| | | All resources whose Resource-IDs match that combined path(s) |
| | | shall be returned in the filtering result. If the relative path does not |
| | | represent a valid resource, the outcome is the same as if no match |
| | | was found, i.e. there is no corresponding entry in the filtering |
| | | result. |

A response to a request for accessing a resource through the reference points Mca and Mcc may include at least one mandatory parameter and at least one optional parameter. In other words, each defined parameter may be either mandatory or optional according to a requested operation or a mandatory response code. For example, a request message may include at least one parameter among those listed in Table 4 below.

TABLE 4
Request message parameter

| | |
|---|---|
| Mandatory | Operation - operation to be executed/CREAT, Retrieve, Update, Delete, Notify |
| | To - the address of the target resource on the target CSE |
| | From - the identifier of the message Originator |
| | Request Identifier - uniquely identifies a Request message |
| Operation | Content - to be transferred |
| dependent | Resource Type - of resource to be created |
| Optional | Originating Timestamp - when the message was built |
| | Request Expiration Timestamp - when the request message expires |
| | Result Expiration Timestamp - when the result message expires |
| | Operational Execution Time - the time when the specified operation is to be |
| | executed by the target CSE |
| | Response Type - type of response that shall be sent to the Originator |
| | Result Persistence - the duration for which the reference containing the responses is |
| | to persist |
| | Result Content - the expected components of the result |
| | Event Category - indicates how and when the system should deliver the message |
| | Delivery Aggregation - aggregation of requests to the same target CSE is to be used |
| | Group Request Identifier - Identifier added to the group request that is to be fanned |
| | out to each member of the group |
| | Group Request Target Members-indicates subset of members of a group |
| | Filter Criteria - conditions for filtered retrieve operation |
| | Desired Identifier Result Type - format of resource identifiers returned |
| | Token Request Indicator - indicating that the Originator may attempt Token Request |
| | procedure (for Dynamic Authorization) if initiated by the Receiver |
| | Tokens - for use in dynamic authorization |
| | Token IDs - for use in dynamic authorization |
| | Role IDs - for use in role based access control |
| | Local Token IDs - for use in dynamic authorization |
| | Authorization Signature Indicator - for use in Authorization Relationship Mapping |
| | Authorization Signature - for use in Authorization Relationship Mapping |
| | Authorization Relationship Indicator - for use in Authorization Relationship |
| | Mapping |
| | Semantic Query Indicator - for use in semantic queries |
| | Release Version Indicator - the oneM2M release version that this request message |
| | conforms to. |
| | Vendor Information |

A normal resource includes a complete set of representations of data constituting the base of information to be managed. Unless qualified as either “virtual” or “announced”, the resource types in the present document may be normal resources. A virtual resource may be used to trigger processing and/or a retrieve result. However, a virtual resource may not have a permanent representation in a CSE. An announced resource may contain a set of attributes of an original resource. When an original resource changes, an announced resource may be automatically updated by the hosting CSE of the original resource. The announced resource contains a link to the original resource. Resource announcement enables resource discovery. An announced resource at a remote CSE may be used to create a child resource at a remote CSE, which may not be present as a child of an original resource or may not be an announced child thereof.

To support resource announcement, an additional column in a resource template may specify attributes to be announced for inclusion in an associated announced resource type. For each announced <resourceType>, the addition of suffix “Annc” to the original <resourceType> may be used to indicate its associated announced resource type. For example, resource <containerAnnc> may indicate the announced resource type for <container> resource, and <groupAnnc> may indicate the announced resource type for <group> resource.

An IoT system like oneM2M should support communication among numerous devices. In addition, since many devices generate massive amounts of data, fast processing of such a large amount of data may be required. To this end, an AI technology may be used. In case an AI technology is used, it may be necessary to use an AI model that is sufficiently trained. In some cases, follow-up re-learning may be needed for an initially trained AI model.

There may exist various reasons why re-learning may be performed. For example, in case an environment changes over time, re-learning may be desired to build a better model and to generate a high-quality accurate prediction.

A learning rate of automated machine learning (autoML) may be described as follows. In machine learning and statistics, a learning rate may be a tuning parameter in an optimization algorithm. For example, a learning rate may determine a step size at each iteration while moving toward a minimum of a loss function. A learning rate may be determined according to time and the number of learning datasets, which the present disclosure proposes to describe in detail through an IoT platform.

FIG. 6 illustrates a concept of re-learning supported in an M2M system according to the present disclosure. FIG. 6 illustrates a concept of controlling, by an IoT platform 620, initial training and re-learning for an AI/ML model 630.

Referring to FIG. 6, after initial training for building the AI/ML model 630, the IoT platform 620 collects data. Herein, the initial training may be performed using training data 614. Real time data thus collected may be used for prediction. That is, the IoT platform 620 performs a predicting operation using the AI/ML model 630 by means of raw data. The IoT platform 620 collects some datasets for future training (e.g., re-learning). When criteria may be satisfied, the IoT platform 620 performs re-learning based on new training data 616. According to various embodiments, the criteria may be defined based on time, an amount of data, and a demand. Re-learning may be performed based on a re-learning criterion as follows.

A criterion may be defined based on time. In this case, re-learning may be performed when a specific time is satisfied. For example, every hour or every specified time (e.g., 00:00) may be set as a time for re-learning.

A criterion may be defined based on an amount of data. In this case, re-learning may be performed when an amount of new training data reaches a given value. For example, if the criterion is set to 1,000 labeled datasets, the IoT platform may perform re-learning when 1,000 labeled datasets are collected for training.

A criterion may be defined based on a size of data. In this case, re-learning may be performed when a size of new training data reaches a given value. For example, if the criterion is set to 1 gigabyte, the IoT platform may perform re-learning when a size of data reaches 1 gigabyte.

A criterion may be defined on demand. In this case, when an administrator application generates a request to perform re-learning, the IoT platform may perform re-learning. In case there is no data collected for re-learning, the IoT platform may neglect the request.

A criterion may be defined based on an accuracy rate. In this case, when the accuracy rate is below a specific level, the IoT platform may perform re-learning. An accuracy rate for prediction may be measured for this scheme.

According to the above-listed various criteria, re-learning may be performed. However, the above-described criteria are only examples, and other criteria may be applied for re-learning according to various embodiments. Furthermore, conditions for re-learning may be combined. For example, in case an amount of data and a size of data may be combined, when the amount of data exceeds 1,000 and the size of data exceeds 1 gigabyte, re-learning may be performed.

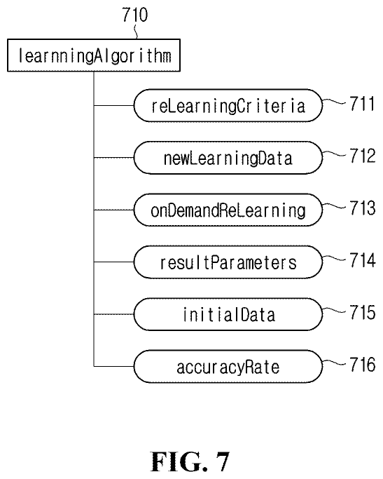

FIG. 7 illustrates an example of a resource including information on re-learning in an M2M system according to the present disclosure. In the example of FIG. 7, a resource containing information on re-learning may be expressed as ‘learningAlgorithm’ 710, but the name of a resource may be different according to various embodiments. Referring to FIG. 7, the resource ‘learningAlgorithm’ 710 may include a plurality of attributes or resources 711 to 716. Each attribute or resource may be described in Table 5 below.

TABLE 5

| Attribute/Resource | Description |
|---|---|
| learningAlgorithm | A resource representing a specific |
| | learning algorithm |
| reLearningCriteria | Combination of criteria for re-learning |
| newLearningData | A set of new learning data |
| onDemandReLearning | A resource to trigger re-learning. |
| | If the resource is set to a positive |
| | value, it is interpreted |
| | to request re-learning, and re- |
| | learning on demand is supported. |
| resultParameters | Result tuning parameters after re-learning |
| initialData | A set of initial learning data |
| accuracyRate | Represents an average accuracy rate |
| | for the prediction |

Information on re-learning according to various embodiments may be managed through resources in FIG. 7.

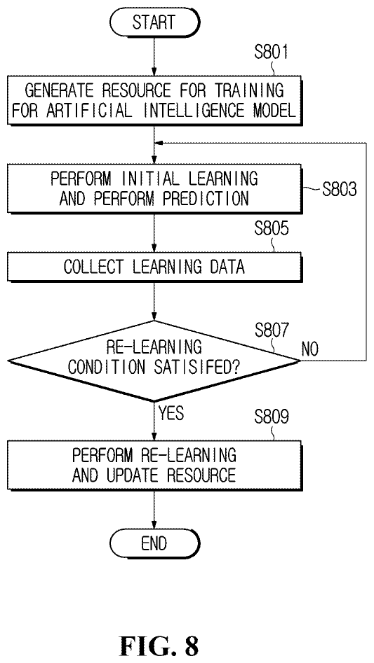

FIG. 8 illustrates an example of a procedure of controlling learning for an AI model in an M2M system according to the present disclosure. The operation subject of FIG. 8 may be a device (e.g., CSE) that controls the training of an AI model. In the description below, the operation subject of FIG. 8 is referred to as ‘device’.

Referring to FIG. 8, at step S801, the device generates a resource for training of an AI model. For example, the device may generate a resource in response to establishing a connection with another entity that operates the AI model. According to an embodiment, the resource may include at least one of information indicating a learning algorithm, information defining a re-learning triggering criterion, information for storing learning data, information for storing a (re-)learning result, information for storing initial learning data, and information indicating an accuracy rate for prediction using the AI model. Herein, the information may be understood as a resource or an attribute. At this time, information may be generated without having a value.

At step S803, the device performs initial learning and performs prediction. The device may perform initial learning for the AI model by using initial learning data stored in a resource. At this time, an operation (e.g., prediction, loss function calculation, back propagation) for the initial learning may be performed by the device or another device (e.g., CSF). In case the operation for the initial learning may be performed by another device, the device may transmit information on the AI model and learning data to the another device and receive a learning result. In addition, a predicting operation may be performed by the device or another device (e.g., AE).

At step S805, the device collects learning data. After the initial learning is completed, while the AI model thus learned is being operated, the device may collect learning data for re-learning. For example, the device may collect at least a portion of data obtained for prediction as learning data for re-learning. According to an embodiment, the device may obtain newly labeled data by providing data, which is input for prediction, to a third entity generating a label and obtaining the label. According to another embodiment, the device may obtain newly labeled data by performing data augmentation based on data, which is input for prediction, and a prediction result. Apart from these, many other methods may be used to obtain newly labeled data. Learning data collected for re-learning may be stored in the resource that is generated at step S801.

At step S807, the device checks whether or not a re-learning condition is satisfied. The re-learning condition is stored in the resource generated at step S801 and may be defined based on at least one of various factors. For example, the re-learning condition may be defined based on at least one of a time, an amount of collected data, a size of collected data, an accuracy rate of AI model, and a demand. In case the re-learning condition is not satisfied, the device returns to step S803.

In case the re-learning condition is satisfied, at step S809, the device performs re-learning and updates a resource. The device may perform initial learning for the AI model by using learning data for re-learning stored in the resource. At this time, an operation (e.g., prediction, loss function calculation, back propagation) for the initial learning may be performed by the device or another device (e.g., CSF). In case the operation for the initial learning is performed by another device, the device may transmit information on the AI model and learning data to the another device and receive a learning result. When the re-learning is completed, the device may store information on the re-learned AI model in the resource. For example, the device may store information on a re-learning history and information on a result of re-learning in the resource. In addition, the device may delete the learning data used for re-learning from the resource.

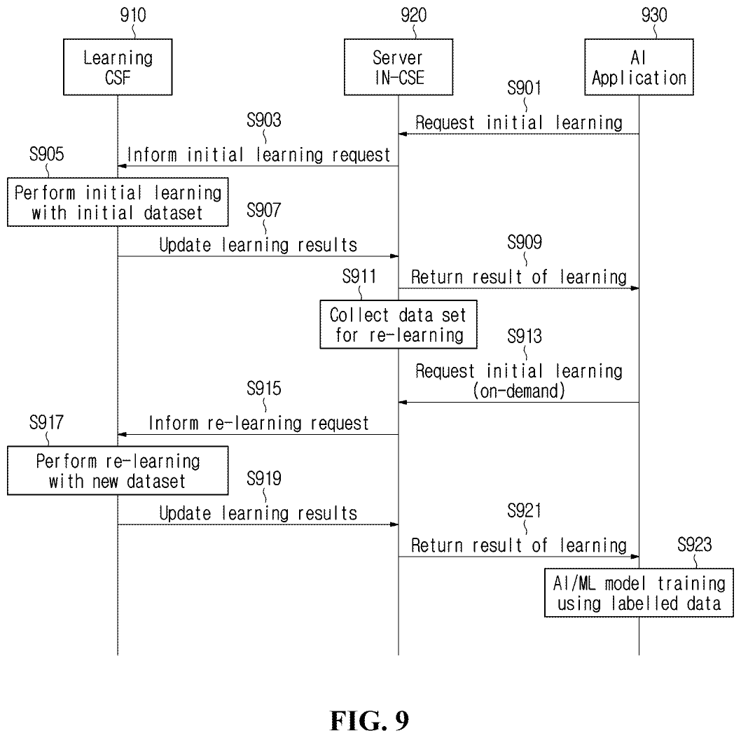

FIG. 9 illustrates an example of a procedure of performing re-learning in an M2M system according to the present disclosure. FIG. 9 exemplifies signal exchanges among a learning CSF 910 that performs training, a server IN-CSE 920 that controls training for an AI model, and an AI application 930 using the AI model. Herein, using an AI model may be understood as operating the AI model itself or providing input data to another device operating the AI model and receiving output data.

Referring to FIG. 9, at step S901, the AI application 930 transmits a request for initial learning to the server IN-CSE 920. In other words, the AI application 930 transmits a message for requesting initial learning for building an AI model to the server IN-CSE 920. Herein, the message includes information necessary to perform training for the AI model. For example, the message may include at least one of information on a structure of the AI model, information on a weight, and information on a training method.

At step S903, the server IN-CSE 920 transmits information on the initial learning request to the learning CSF 910. In other words, the server IN-CSE 920 informs the learning CSF 910 of occurrence of the request to perform initial learning and transmits information necessary to perform initial learning. For example, the information necessary to perform the initial learning may include at least one of information on a structure of the AI model, information on a weight, and information on a training method. In addition, according to an embodiment, the server IN-CSE 920 may provide a set of learning data for initial learning.

At step S905, the learning CSF 910 performs initial learning by using an initial dataset. Being a set of learning data, the initial dataset may be provided from the server IN-CSE 920 or be collected by the learning CSF 910. The learning CSF 910 may build an AI model by performing initial learning based on information that is provided from the server IN-CSE 920. Specifically, the learning CSF 910 may perform prediction by using learning data, determine a loss value based on a prediction result and a label, and update weight values by performing back-propagation using the loss value.

At step S907, the learning CSF 910 transmits a learning result to the server IN-C SE 920. The learning result includes information on the learned AI model. That is, the learning CSF 910 requests to update a resource for AI model training by means of the learning result. For example, the learning result may include information on weights of the AI model. Accordingly, the server IN-CSE 920 obtains the AI model, for which initial learning is completed, and updates the resource for AI model training.

At step S909, the server IN-CSE 920 transmits a result of learning to the AI application 930. That is, the server IN-CSE 920 returns the result of learning to the AI application 930. Accordingly, the AI application 930 may obtain the AI model thus built and be in a state where it can use the AI model.

At step S911, the server IN-CSE 920 collects a dataset for re-learning. Although not illustrated in FIG. 9, the server IN-CSE 920 may transmit data, which is received from at least one of devices connected to the server IN-CSE 920, to the AI application 930, receive a prediction result using the AI model from the AI application 930, and perform a necessary operation by using the prediction result. At this time, the server IN-CSE 920 may collect at least a portion of received data as learning data for re-learning.

At step S913, the AI application 930 transmits a request for re-learning to server IN-CSE 920. In other words, the AI application 930 transmits a message for requesting re-learning for the AI model to the server IN-CSE 920. Herein, the request of the AI application 930 may be meaningful when an on-demand criterion is applied. Herein, the message includes information necessary to perform training for the AI model. For example, the message may include at least one of information on a structure of the AI model, information on a weight, and information on a training method.

At step S915, the server IN-CSE 920 transmits information on the re-learning request to the learning CSF 910. In other words, the server IN-CSE 920 informs the learning CSF 910 of occurrence of a request to perform re-learning and transmits information necessary to perform re-learning. For example, the information necessary to perform the initial learning may include at least one of information on a structure of the AI model, information on a weight, and information on a training method. In addition, according to an embodiment, the server IN-CSE 920 may provide a set of learning data for re-learning. For example, the learning data for re-learning may include at least a portion of the dataset collected at step S911.

At step S917, the learning CSF 910 performs re-learning by using a new dataset. The new dataset, which is a set of learning data, may be received from the server IN-CSE 920. The learning CSF 910 may update or reinforce the AI model by performing re-learning based on information that is provided from the server IN-CSE 920. Specifically, the learning CSF 910 may perform prediction by using learning data, determine a loss value based on a prediction result and a label, and update weight values by performing back-propagation using the loss value.

At step S919, the learning CSF 910 transmits a learning result to the server IN-C SE 920. The learning result includes information on the learned AI model. That is, the learning CSF 910 requests to update a resource for AI model training by means of the learning result. For example, the learning result may include information on weights of the AI model. Accordingly, the server IN-CSE 920 obtains the AI model, for which initial learning is completed, and updates the resource for AI model training.

At step S921, the server IN-CSE 920 transmits a result of learning to the AI application 930. That is, the server IN-CSE 920 returns the result of learning to the AI application 930. Accordingly, the AI application 930 may obtain the AI model thus built and be in a state where it can use the AI model. Accordingly, at step S923, the AI application 930 performs an operation by using an AI/ML model that is trained with labeled data.

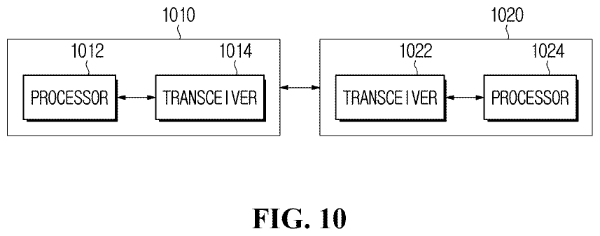

FIG. 10 illustrates a configuration of an M2M device in an M2M system according to the present disclosure. An M2M device 1010 or an M2M device 1020 illustrated in FIG. 10 may be understood as hardware functioning as at least one among the above-described AE, CSE and NSE.

Referring to FIG. 10, the M2M device 1010 may include a processor 1012 controlling a device and a transceiver 1014 transmitting and receiving a signal. Herein, the processor 1012 may control the transceiver 1014. In addition, the M2M device 1010 may communicate with another M2M device 1020. The another M2M device 1020 may also include a processor 1022 and a transceiver 1024, and the processor 1022 and the transceiver 1024 may perform the same function as the processor 1012 and the transceiver 1014.

As an example, the originator, the receiver, AE and CSE, which may be described above, may be one of the M2M devices 1010 and 1020 of FIG. 10, respectively. In addition, the devices 1010 and 1020 of FIG. 10 may be other devices. As an example, the devices 1010 and 1020 of FIG. 10 may be communication devices, vehicles, or base stations. That is, the devices 1010 and 1020 of FIG. 10 refer to devices capable of performing communication and may not be limited to the above-described embodiment.

The above-described exemplary embodiments of the present disclosure may be implemented by various means. For example, the exemplary embodiments of the present disclosure may be implemented by hardware, firmware, software, or a combination thereof.

The foregoing description of the exemplary embodiments of the present disclosure has been presented for those skilled in the art to implement and perform the disclosure. While the foregoing description has been presented with reference to the preferred embodiments of the present disclosure, it will be apparent to those skilled in the art that various modifications and variations may be made in the present disclosure without departing from the spirit or scope of the present disclosure as defined by the following claims.

Accordingly, the present disclosure is not intended to be limited to the exemplary embodiments shown herein but is to be accorded the widest scope consistent with the principles and novel features disclosed herein. In addition, while the exemplary embodiments of the present specification have been particularly shown and described, it is to be understood that the present specification is not limited to the above-described exemplary embodiments, but, on the contrary, it will be understood by those skilled in the art that various changes and modifications may be made without departing from the spirit and scope of the present specification as defined by the claims below, and such changes and modifications should not be individually understood from the technical thought and outlook of the present specification.

In this specification, both the disclosure and the method disclosure are explained, and the description of both disclosures may be supplemented as necessary. In addition, the present disclosure has been described with reference to exemplary embodiments thereof. It will be understood by those skilled in the art that various changes in form and details may be made therein without departing from the essential characteristics of the present disclosure. Therefore, the disclosed exemplary embodiments should be considered in an illustrative sense rather than in a restrictive sense. The scope of the present disclosure is defined by the appended claims rather than by the foregoing description, and all differences within the scope of equivalents thereof should be construed as being included in the present disclosure.

What is claimed is:

1. A method for operating a device in a machine-to-machine (M2M) system, the method comprising:
generating a resource for training an artificial intelligence (AI) model;
controlling to perform initial learning of the AI model;
collecting learning data for re-learning for the AI model; and
controlling to perform re-learning of the AI model by using the learning data.

2. The method of claim 1, wherein the resource includes at least one of first information comprising a learning algorithm, second information defining a re-learning triggering criterion, third information for storing the learning data, fourth information for storing a result of the re-learning, fifth information for storing initial learning data, and sixth information indicating an accuracy rate for prediction using an artificial intelligence model.

3. The method of claim 1, wherein the controlling to perform the re-learning comprises performing the re-learning when a condition for the re-learning is satisfied.

4. The method of claim 3, wherein the condition includes at least one of arrival of a specified hour, the learning data for the re-learning being collected by a specified amount, the learning data for the re-learning being collected at a specified size, occurrence of a request for the re-learning, and a prediction accuracy rate of the artificial intelligence model being below a threshold.

5. The method of claim 3, wherein the condition includes the request for the re-learning that is received from another device that operates the artificial intelligence model.

6. The method of claim 1, wherein the learning data for the re-learning is generated based on data input that is input for prediction using the artificial intelligence model with the initial learning.

7. The method of claim 6, wherein the learning data for the re-learning includes the data input for prediction and a label that is generated by an entity which generates the label based on the data input.

8. The method of claim 6, wherein the learning data for the re-learning includes data augmented from the data input that is input for prediction.

9. The method of claim 1, wherein the controlling to perform the re-learning further comprises:
transmitting the learning data for re-learning to another device that performs learning for the artificial intelligence model; and
receiving information on the artificial intelligence model that is re-learned by the another device.

10. The method of claim 1, wherein the controlling to perform the initial learning comprises:
transmitting learning data for initial learning to another device that performs learning for the artificial intelligence model; and
receiving information on the artificial intelligence model that is initially learned by the another device.

11. An apparatus in a machine-to-machine (M2M) system, comprising:
a transceiver; and
a processor coupled with the transceiver, wherein the processor is configured to:
generate a resource for training an artificial intelligence (AI) model,
perform initial learning of the artificial intelligence model,
collect learning data for re-learning for the artificial intelligence model, and
perform re-learning of the artificial intelligence model by using the learning data.

12. The apparatus of claim 11, wherein the resource includes at least one of first information indicating a learning algorithm, second information defining a re-learning triggering criterion, third information for storing the learning data, fourth information for storing a result of the re-learning, fifth information for storing initial learning data, and sixth information indicating an accuracy rate for prediction using an artificial intelligence model.

13. The apparatus of claim 11, wherein the processor is further configured to perform the re-learning when a condition for the re-learning is satisfied.

14. The apparatus of claim 13, wherein the condition includes at least one of arrival of a specified hour, the learning data for the re-learning being collected by a specified amount, the learning data for the re-learning being collected to a specified size, occurrence of a request for the re-learning, and a prediction accuracy rate of the artificial intelligence model being below a threshold.

15. The apparatus of claim 13, wherein the request for the re-learning is received from another device that operates the artificial intelligence model.

16. The apparatus of claim 11, wherein the learning data for the re-learning is generated based on data input that is input for prediction using the initially-learned artificial intelligence model.

17. The apparatus of claim 16, wherein the learning data for the re-learning includes the data input for the prediction and a label that is generated by an entity that generates a label based on the data input.

18. The apparatus of claim 16, wherein the learning data for the re-learning includes data augmented from the data input that is input for the prediction.

19. The apparatus of claim 11, wherein the processor is further configured to:
transmit the learning data for the re-learning to another device that performs learning for the artificial intelligence model, and
receive information on the artificial intelligence model that is re-learned by the another device.

20. The apparatus of claim 11, wherein the processor is further configured to:
transmit learning data for the initial learning to another device that performs learning for the artificial intelligence model, and
receive information on the artificial intelligence model that is initially learned by the another device.
